(19) United States
(12) Patent Application Publication
(10) Pub. No.: US 2026/0115988 A1
(43) Pub. Date: Apr. 30, 2026

(54) PRE-PERFORATED STRETCH FILM AND METHOD

(71) Applicant: Allied Packaging Corporation, Phoenix, AZ (US)

(72) Inventors: Darrel BISON, Phoenix, AZ (US); Steven D. SMITH, Phoenix, AZ (US)

(21) Appl. No.: 18/930,827

(22) Filed: Oct. 29, 2024

(51) Int. Cl. B29C 48/00; B29C 48/08; B29C 48/10; B29C 48/28; B29C 48/355; B29L 31/00

(52) U.S. Cl. CPC B29C 48/0022; B29C 48/08; B29C 48/10; B29C 48/28; B29C 48/355; B29C 2793/0045; B29C 2793/009; B29K 2995/0065; B29L 2031/712

(57) ABSTRACT

A method and system for perforating stretch film. The stretch film may be extruded using a cast film or blown film extrusion process. The stretch film may be passed over a first idler roller and moved in a first direction toward a perforation roller. The perforation roller may have a center axle and a plurality of perforation rings, each of which has an outer ring, a plurality of pins extending through the outer ring, and an inner ring configured to hold the plurality of pins in an extended position through the outer ring. The stretch film may be perforated with the perforation roller as the stretch film passes over the perforation roller. The perforated stretch film may be moved in a second direction away from the perforation roller, passed over a second idler roller, and wrapped about a core to form a roll of perforated stretch film.

### TECHNICAL FIELD

This document relates to a method and system for forming a pre-perforated stretch film.

### BACKGROUND

Efficient and secure packaging of palletized loads is crucial for safeguarding goods during storage and transportation. Stretch film is commonly employed for this purpose due to its excellent ability to conform to the shape of the load and its strength in holding items together. Traditionally, stretch film is applied in a continuous, solid sheet that is manually or mechanically wrapped around the load. This process, while effective, has several limitations that can impact efficiency and effectiveness.

One major limitation of conventional stretch film is its lack of breathability. When wrapping goods, particularly those that are sensitive to moisture, the absence of ventilation can lead to condensation and spoilage. For this reason, some goods are wrapped with other materials that can provide the necessary ventilation, such as a mesh material. However, these alternative materials do not provide the same level of support to the palletized load as stretch film.

### SUMMARY

Aspects of this document relate to a method of perforating stretch film for tightly wrapping a load, the method comprising extruding a stretch film using either a cast film or a blown film extrusion process, wherein the stretch film is configured to stretch by at least 100% and maintain a compressive force on the load when the load is wrapped with the stretch film, passing the stretch film over a first idler roller, moving the stretch film in a first direction towards a perforation roller, wherein the perforation roller comprises a center axle and a plurality of perforation rings positioned on and axially aligned with the center axle, wherein each of the plurality of perforation rings is configured to perforate the stretch film when the stretch film passes over the plurality of perforation rings, each of the plurality of perforation rings having an outer ring having a plurality of pinholes extending therethrough, wherein the plurality of pinholes are spaced apart around a circumference of the outer ring, a plurality of pins having tapered ends configured to extend through the plurality of pinholes, wherein each of the plurality of pins has a stem with a maximum diameter larger than a minimum diameter of the plurality of pinholes, and an inner ring configured to sit inside of the outer ring and hold the plurality of pins in an extended position with the tapered ends of the plurality of pins extending through the plurality of pinholes, perforating the stretch film with the perforation roller as the stretch film passes over the perforation roller, moving the perforated stretch film in a second direction away from the perforation roller, wherein an angle between the first direction and the second direction is at least 150 degrees, passing the perforated stretch film over a second idler roller, and wrapping the perforated stretch film about a core to form a roll of perforated stretch film.

Particular embodiments may comprise one or more of the following features. Each of the tapered ends of the plurality of pins may have a length of at least 0.125 inches. The maximum diameter of each of the plurality of pins may be less than or equal to 0.1 inches. Perforating the stretch film may comprise creating a plurality of perforations through the stretch film, wherein the plurality of perforations are spaced between one and four inches apart. The angle between the first direction and the second direction may be at least 180 degrees.

Aspects of this document relate to a method of perforating stretch film for tightly wrapping a load, the method comprising extruding a stretch film, wherein the stretch film is configured to stretch by at least 100% and maintain a compressive force on the load when the load is wrapped with the stretch film, moving the stretch film in a first direction towards a perforation roller, wherein the perforation roller comprises a center axle and a plurality of perforation rings positioned on and axially aligned with the center axle, wherein each of the plurality of perforation rings is configured to perforate the stretch film when the stretch film passes over the plurality of perforation rings, perforating the stretch film with the perforation roller as the stretch film passes over the perforation roller, moving the perforated stretch film in a second direction away from the perforation roller, and wrapping the perforated stretch film about a core to form a roll of perforated stretch film.

Particular embodiments may comprise one or more of the following features. The stretch film may be extruded using either a cast film or a blown film extrusion process. An angle between the first direction and the second direction may be at least 150 degrees. Each of the plurality of perforation rings may have an outer ring having a plurality of pinholes extending therethrough, a plurality of pins configured to extend through the plurality of pinholes, wherein each of the plurality of pins has a maximum diameter larger than a minimum diameter of the plurality of pinholes, and an inner ring configured to sit inside of the outer ring and hold the plurality of pins in an extended position with the plurality of pins extending through the plurality of pinholes. Each of the plurality of pins may have a tapered end with a length of at least 0.125 inches. The maximum diameter of each of the plurality of pins may be less than or equal to 0.1 inches. Perforating the stretch film may comprise creating a plurality of perforations through the stretch film, wherein the plurality of perforations are spaced between one and four inches apart.

Aspects of this document relate to a method of perforating stretch film for tightly wrapping a load, the method comprising extruding a stretch film, wherein the stretch film is configured to stretch by at least 100% and maintain a compressive force on the load when the load is wrapped with the stretch film, perforating the stretch film, and wrapping the perforated stretch film about a core to form a roll of perforated stretch film.

Particular embodiments may comprise one or more of the following features. The method may further comprise moving the stretch film in a first direction towards a perforation roller prior to perforating the stretch film and moving the stretch film in a second direction away from the perforation roller after perforating the stretch film, wherein an angle between the first direction and the second direction is at least 150 degrees. The stretch film may be extruded using either a cast film or a blown film extrusion process. Perforating the stretch film may comprise perforating the stretch film with a perforation roller configured to perforate the stretch film when the stretch film passes over the perforation roller. The perforation roller may comprise a center axle and a plurality of perforation rings positioned on and axially aligned with the center axle. Each of the plurality of perforation rings may have an outer ring having a plurality of pinholes extending therethrough and a plurality of pins configured to extend through the plurality of pinholes, wherein each of the plurality of pins has a maximum diameter larger than a minimum diameter of the plurality of pinholes. Each of the plurality of perforation rings may further have an inner ring configured to sit inside of the outer ring and hold the plurality of pins in an extended position with the plurality of pins extending through the plurality of pinholes. Perforating the stretch film may comprise creating a plurality of perforations through the stretch film, wherein the plurality of perforations are spaced between one and four inches apart.

The foregoing and other aspects, features, and advantages will be apparent from the DESCRIPTION and DRAWINGS, and from the CLAIMS if any are included.

### BRIEF DESCRIPTION OF THE DRAWINGS

Implementations Will Hereinafter be Described in Conjunction with the Appended and/or Included DRAWINGS, where Like Designations Denote Like Elements, and:

FIG. 1 is a top view of a stretch film perforation system including a stretch film extrusion system according to some embodiments;

FIG. 2 is a top view of the interior of a stretch film perforation system according to some embodiments;

FIG. 3 is a perspective view of a perforation roller according to some embodiments;

FIG. 4 is a perspective view of a perforation ring of a perforation roller according to some embodiments;

FIG. 5 is an exploded view of a perforation ring of a perforation roller according to some embodiments

FIG. 6 is a front view of a perforation ring of a perforation roller according to some embodiments;

FIG. 7 is a right-side view of a perforation ring of a perforation roller according to some embodiments;

FIG. 8 is a rear view of a perforation ring of a perforation roller according to some embodiments;

FIG. 9 is a top view of a perforation ring of a perforation roller according to some embodiments; and

FIG. 10 is a perspective view of a perforation pin of a perforation roller according to some embodiments.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

As mentioned above, conventional methods of wrapping a palletized load require that the benefits of security of the load and breathability of the load be balanced, as increasing security tends to decrease breathability and vice versa. To address this issue, the present disclosure provides a pre-perforated stretch film that combines the benefits that stretch film provides with the ability of perforations to enhance air circulation and facilitate easier handling. The concept of incorporating perforations into stretch film is designed to offer a more efficient and versatile wrapping solution. By introducing pre-formed perforations, the film allows for better air flow around the palletized load, thereby reducing the risk of moisture buildup and potential damage to the wrapped goods.

The present disclosure also addresses several technical challenges that arise from perforating stretch film. These include ensuring the integrity and strength of the film despite the presence of perforations, maintaining the desired stretchability and cling properties, and effectively integrating the perforation process with film manufacturing without compromising production efficiency. The present disclosure enhances the functionality of stretch film in palletizing applications, ultimately contributing to better protection of goods and more streamlined packaging processes.

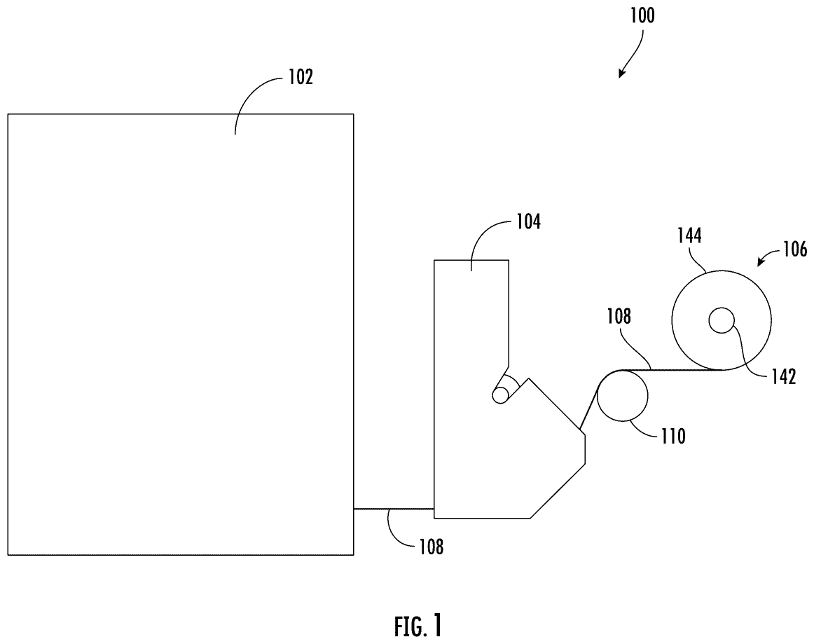

The present disclosure is related to a stretch film manufacturing system 100 and a method for manufacturing pre-perforated stretch film. As illustrated in FIG. 1, the stretch film manufacturing system 100 may comprise an extruder 102, a perforation roller assembly 104, and/or a winding system 106. The extruder 102 may be any extrusion machine that is configured to extrude and form stretch film 108. For example, the extruder 102 may be a cast film line or a blown film line, such as those sold by Macro Engineering & Technology Inc. Regardless of the specific machine implemented, the extruder 102 is configured to produce stretch film 108 in a continuous sheet that is configured to stretch by at least 100% and maintain a compressive force on a load when the load is wrapped with the stretch film 108. In some embodiments, the stretch film 108 is configured to stretch by at least 150%, by at least 200%, by at least 250%, or by at least 300% on a load when the load is wrapped with the stretch film 108, such as a pallet load to be shipped. Once the stretch film 108 has been extruded from the extruder 102, the perforation roller assembly 104 is configured to form perforations in the stretch film 108 and the winding system 106 is configured to wind the stretch film 108 up into a roll 144 of stretch film 108 to be used to wrap a palletized load. Thus, the present disclosure provides a significant advantage over currently known methods of providing ventilation for wrapped goods because the perforations are formed in the stretch film 108 as the stretch film 108 is extruded, prior to wrapping the stretch film 108 up into a roll 144 of stretch film 108. Currently known methods, which either do not use stretch film 108 or use stretch film 108 without perforations (such as netting), are implemented after manufacture of the material, adding to the cost of wrapping the load. The present disclosure creates the perforations as the stretch film 108 is extruded, thus simplifying the process and decreasing costs.

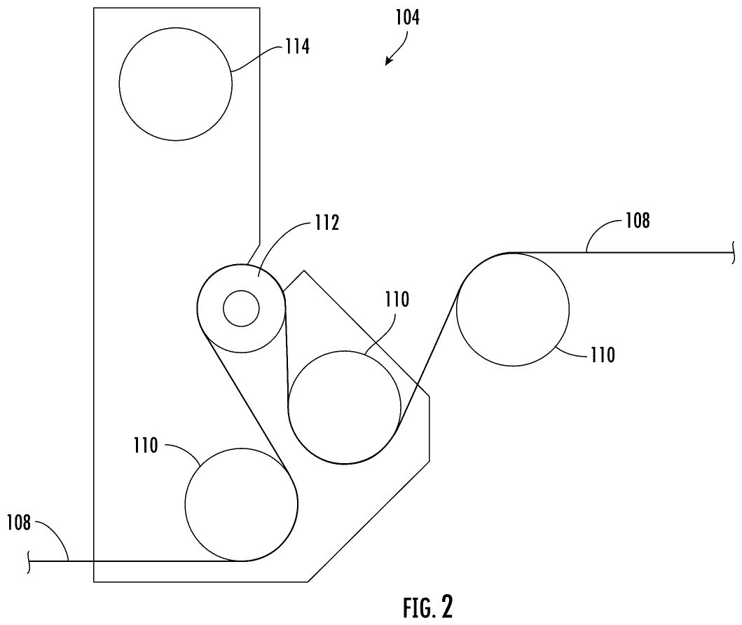

The perforation roller assembly 104 is configured to perforate the stretch film 108. The perforation roller assembly 104 may comprise an idler roller 110, a perforation roller 112, and/or a bypass roller 114. The idler roller 110 is configured to guide the stretch film 108 through the perforation roller assembly 104 and position the stretch film 108 for the perforation roller 112 to effectively perforate the stretch film 108. The idler roller 110 is configured to rotate freely about its axis, thus letting the idler roller 110 rotate with the stretch film 108 when stretch film 108 is positioned in contact with the idler roller 110 and the stretch film 108 is passed over the idler roller 110. In some embodiments, multiple idler rollers 110 may be implemented to guide the stretch film 108 through the perforation roller assembly 104. For example, as shown in FIG. 2, the perforation roller assembly 104 may comprise a first idler roller 110 positioned before the perforation roller 112 and a second idler roller 110 positioned after the perforation roller 112. The idler rollers 110 may be positioned such that the stretch film 108 turns by at least 150 degrees when passing over the perforation roller 112, as shown in FIG. 2. In some embodiments, the idler rollers 110 are positioned such that the stretch film 108 turns by at least 180 degrees. By turning the stretch film 108 by a greater angle, there is no need to push the stretch film 108 down onto the perforation roller 112. Instead, the stretch film 108 is pulled against the perforation roller 112 to form the perforations.

The bypass roller 114 is positioned to allow the stretch film 108 to bypass the perforation roller 112 as the stretch film 108 passes through the perforation roller assembly 104. This is beneficial because, in embodiments with the bypass roller 114, the perforation roller assembly 104 does not need to be removed if the user desires to manufacture some stretch film 108 that does not have perforations. Instead, whether perforations are created is determined by whether the stretch film 108 passes over the perforation roller 112 or the bypass roller 114.

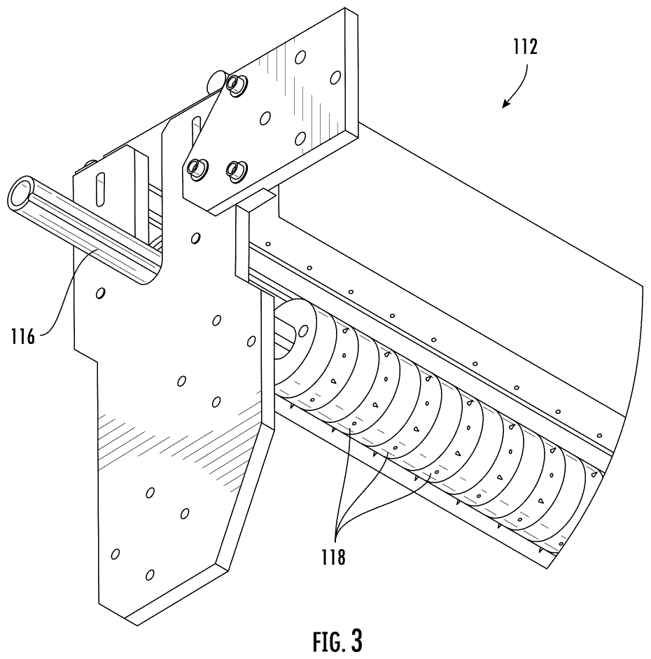

The perforation roller 112 may comprise a center axle 116 and a plurality of perforation rings 118, as illustrated by the embodiment shown in FIG. 3. Each of the perforation rings 118 is positioned on and is axially aligned with the center axle 116. This allows the perforation rings 118 to rotate about the center axle 116 as the stretch film 108 passes over the perforation roller 112. Each of the perforation rings 118 is configured to perforate the stretch film 108 when the stretch film 108 passes over the perforation rings 118.

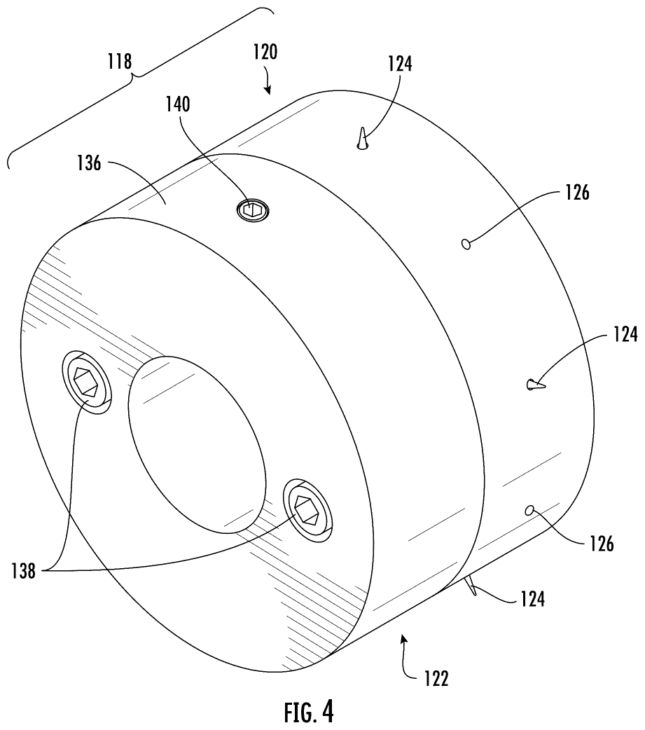

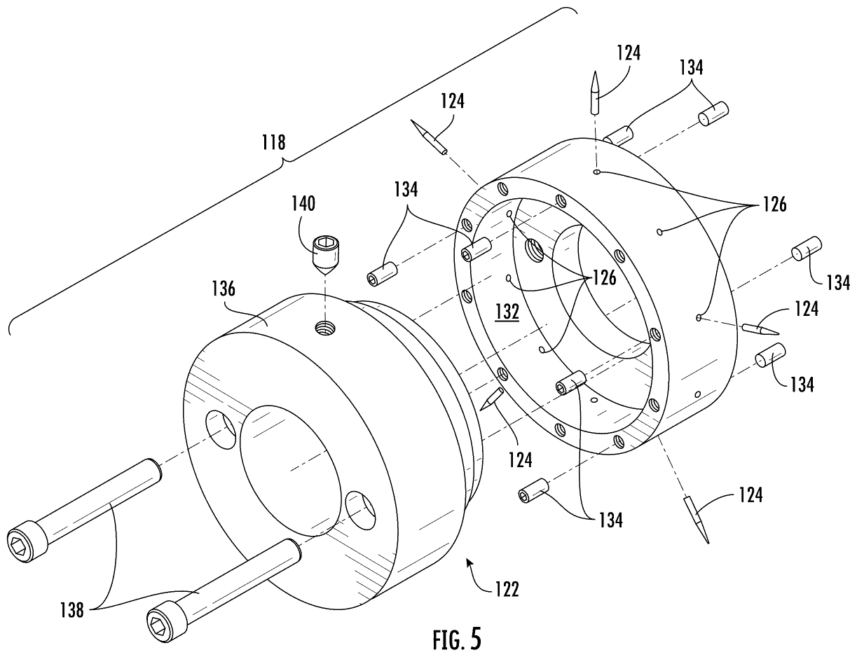

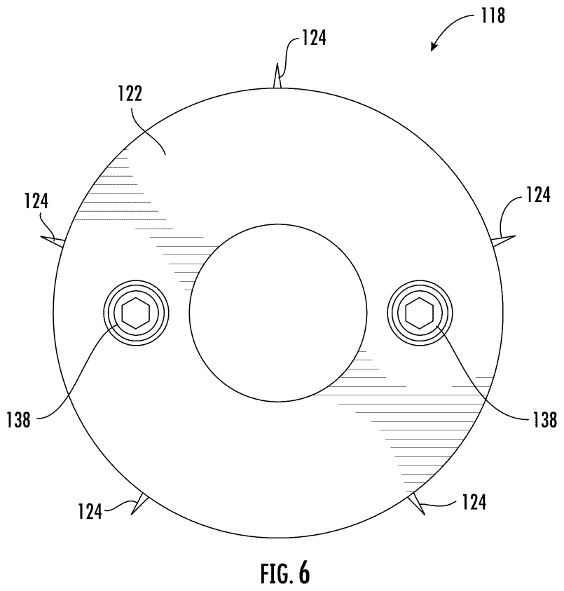

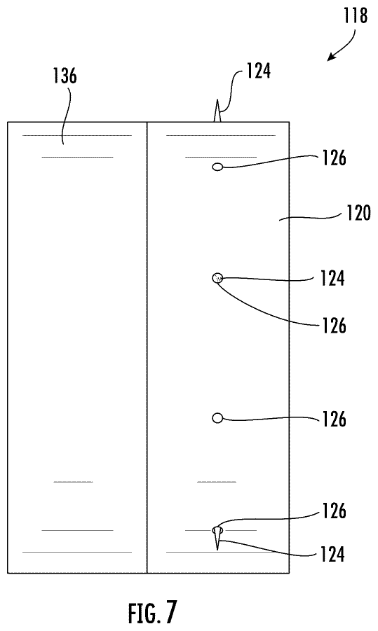

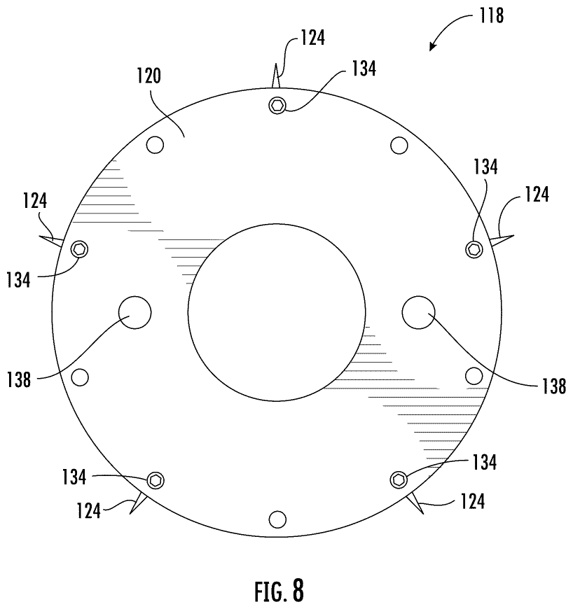

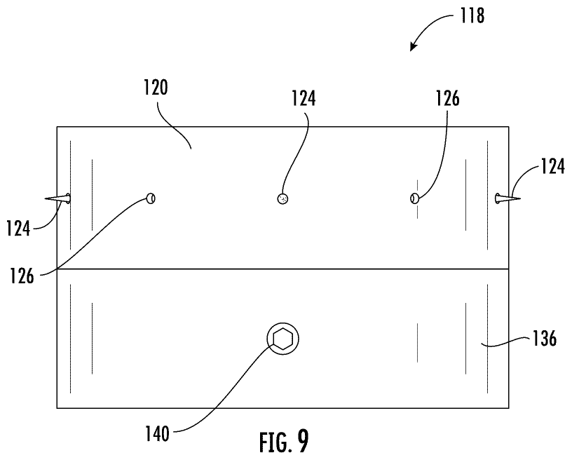

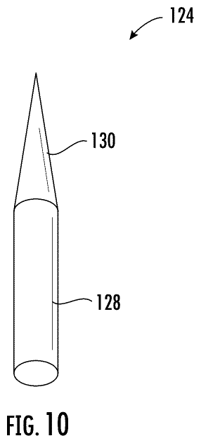

In some embodiments, each of the perforation rings 118 comprises an outer ring 120, an inner ring 122, and a plurality of pins 124, as illustrated in the embodiment shown in FIGS. 4-9. The outer ring 120 may comprise a plurality of pinholes 126 extending through the outer ring 120. The plurality of pinholes 126 may be spaced apart around a circumference of the outer ring 120. The plurality of pins 124 are configured to be positioned in and/or extend through the plurality of pinholes 126. In some embodiments, each of the plurality of pins 124 has a stem 128 and a tapered end 130 opposite the stem 128, as illustrated by the embodiment shown in FIG. 10. The stem 128 may be configured to be positioned within the outer ring 120, while the tapered end 130 may be configured to extend outward from the outer ring 120. In some embodiments, the tapered end 130 of each of the plurality of pins 124 has a length of at least ⅛ inch. However, it will be apparent to one of skill in the art that the length of the tapered end 130 of each of the plurality of pins 124 may be longer or shorter than 0.125 inches. In some embodiments, the tapered end 130 of each of the plurality of pins 124 has a length between 1/16 inch and ¼ inch.

A variety of methods may be implemented to maintain the plurality of pins 124 within the plurality of pinholes 126. In some embodiments, the stem 128 of each of the plurality of pins 124 has a maximum diameter that is larger than a minimum diameter of each of the plurality of pinholes 126. In such embodiments, the plurality of pins 124 may be inserted into the plurality of pinholes 126 from an inside surface 132 of the outer ring 120. This allows the plurality of pins 124 to be inserted into the plurality of pinholes 126 but prevents the plurality of pins 124 from passing completely through the plurality of pinholes 126 because the minimum diameter of each of the plurality of pinholes 126 is smaller than a maximum diameter of each of the plurality of pins 124. In some embodiments, the perforations created by the plurality of pins 124 have a diameter less than or equal to ½ inch. In some embodiments, the diameter of the perforations are less than or equal to ¼ inch. In some embodiments, the maximum diameter of each of the plurality of pins 124 is less than or equal to 0.1 inches. This leads to the plurality of pins 124 creating relatively small perforations or holes in the stretch film 108 when the stretch film 108 passes over the perforation roller 112. These smaller holes can later be expanded to the desired size when the stretch film 108 is wrapped around a palletized load, allowing for the improved ventilation discussed above. As will be apparent to one of skill in the art, the plurality of pins 124 may have a maximum diameter that is smaller or larger than 0.1 inches.

In some embodiments, each of the perforation rings 118 may also comprise a plurality of tighteners 134. The plurality of tighteners 134 may be threadedly coupled to the outer ring 120 and may be configured to tighten up against the plurality of pins 124 within the outer ring 120. This allows the plurality of pins 124 to be positioned at the desired depth within the plurality of pinholes 126 and then locked into place with the plurality of tighteners 134 because the plurality of tighteners 134 push against the plurality of pins 124, using friction to prevent further movement of the plurality of pins 124 within the plurality of pinholes 126. In some embodiments, multiple methods of maintaining the plurality of pins 124 within the plurality of pinholes 126 may be implemented.

The inner ring 122 is configured to at least partially insert into the outer ring 120 and sit inside of the outer ring 120. This allows the inner ring 122 to cover the inside surface 132 of the outer ring 120, and therefore help to hold the plurality of pins 124 in an extended position with the tapered end 130 of each of the plurality of pins 124 extending through the plurality of pinholes 126. The inner ring 122 may also comprise a spacer 136 which is configured to separate the outer ring 120 of each perforation ring 118 from the outer ring 120 of adjacent perforation rings 118. The inner ring 122 may be attached to the outer ring 120 with one or more fasteners 138. Each of the perforation rings 118 may also have one or more tighteners 140 that are configured to insert radially into the outer ring 120 or the inner ring 122 toward the center axle 116. The one or more tighteners 140 can thus be used to fix each perforation ring 118 in place on the center axle 116 such that the perforation ring 118 is rotationally fixed with respect to the center axle 116 and also fixed in place along the length of the center axle 116.

The plurality of pins 124 are configured to extend out from the outer ring 120 and are configured to perforate the stretch film 108 when the stretch film 108 passes over the perforation rings 118 as described above. As the stretch film 108 passes over the perforation rings 118, the plurality of pins 124 moves with the stretch film 108, allowing the plurality of pins 124 to puncture the stretch film 108 at specific points where the plurality of pins 124 make contact with the stretch film 108, rather than tearing the stretch film 108 as would occur if the plurality of pins 124 did not move with the stretch film 108. The plurality of pins 124 may comprise any number of pins. The perforation rings 118 may be adaptable, allowing the user to select a desired number of pins for the plurality of pins 124. In addition, because the plurality of pins 124 are detachable from the perforation rings 118, pins that break or otherwise need to be replaced or sharpened can be easily detached and replaced with new pins. The plurality of pins 124 may be spaced apart such that the perforations created by the plurality of pins 124 in the stretch film 108 are spaced between one and four inches apart. Depending on the embodiment, the perforations may be spaced one inch apart, two inches apart, three inches apart, or four inches apart. As will be apparent to a person of skill in the art, any other spacing for the perforations may be implemented, including placing the perforations closer together or further apart.

In some embodiments, the stretch film 108 is perforated to leave strips of unperforated stretch film 108 along the edges of the stretch film 108 and/or along a center of the stretch film 108. In some embodiments, these strips are between 1 inch and three inches wide. This allows additional stretch film to be added later during the wrapping of a load to strengthen the stretch film 108 as the perforations are expanded to a larger size and thus avoid undesired tearing of the stretch film 108.

The present disclosure is also related to a method of perforating the stretch film 108 for tightly wrapping a load. As noted above, the stretch film 108 may be extruded as part of this method. In some embodiments, the stretch film 108 is extruded using a cast film extrusion process or a blown film extrusion process. Other extrusion processes may also be implemented. As will be understood by a person of skill in the art, implementing different extrusion processes leads to different material qualities for the stretch film 108. The method may comprise extruding stretch film 108 in a continuous sheet and the stretch film 108 may be configured to stretch by at least 100% and maintain a compressive force on a load when the load is wrapped with the stretch film 108.

The stretch film 108 may be passed over the first idler roller 110 and then moved in a first direction toward the perforation roller 112. As the stretch film 108 passes over the perforation roller 112, the stretch film 108 may be perforated, and the perforated stretch film 108 may then be moved in a second direction away from the perforation roller 112. The angle between the first direction and the second direction may be at least 150 degrees. This helps to ensure that the perforation roller 112 effectively perforates the stretch film 108 before the stretch film 108 is pulled away from the perforation roller 112. In some embodiments, the angle between the first direction and the second direction is at least 180 degrees. As the stretch film 108 is passed over the perforation roller 112, the goal is to pass the stretch film 108 around the perforation roller 112 without adding additional stretch force to the stretch film 108. This allows the plurality of pins 124 to perforate the stretch film 108 without stretching the perforations in an undesirable way. The perforated stretch film 108 may then be passed over the second idler roller 110 and the perforated stretch film 108 may be wrapped about a core 142 to form a roll 144 of perforated stretch film 108. This roll 144 of perforated stretch film 108 can then be transported to individual users that desire to wrap loads with the perforated stretch film 108.

As noted above, the perforated stretch film 108 can later be wrapped around a load. As tension is added to the stretch film 108 during this process, the stretch film 108 is stretched, causing the perforations to stretch and expand. These expanded holes provide the ventilation discussed above, thus allowing a load to be wrapped with stretch film while still provided ventilation. In this way, the present disclosure ensures the integrity and strength of the stretch film despite the presence of perforations, maintains the desired stretchability and cling properties, and effectively integrates the perforation process with film manufacturing without compromising production efficiency. The present disclosure thus enhances the functionality of stretch film in palletizing applications, ultimately contributing to better protection of goods and more streamlined packaging processes.

Many additional implementations are possible. Further implementations are within the CLAIMS.

It will be understood that implementations of the [invention] include but are not limited to the specific components disclosed herein, as virtually any components consistent with the intended operation of various [inventions] may be utilized. Accordingly, for example, it should be understood that, while the drawings and accompanying text show and describe particular [invention] implementations, any such implementation may comprise any shape, size, style, type, model, version, class, grade, measurement, concentration, material, weight, quantity, and/or the like consistent with the intended operation of [inventions].

The concepts disclosed herein are not limited to the specific [invention] shown herein. For example, it is specifically contemplated that the components included in particular [inventions] may be formed of any of many different types of materials or combinations that can readily be formed into shaped objects and that are consistent with the intended operation of the [invention]. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, [inventions] may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular [invention] implementations, it should be readily apparent that a number of modifications may be made without departing from the spirit thereof and that these implementations may be applied to other implementations disclosed or undisclosed. The presently disclosed [inventions] are, therefore, to be considered in all respects as illustrative and not restrictive.

We claim:

1. A method of perforating stretch film for tightly wrapping a load, the method comprising:
extruding a stretch film using either a cast film or a blown film extrusion process, wherein the stretch film is configured to stretch by at least 100% and maintain a compressive force on the load when the load is wrapped with the stretch film;
passing the stretch film over a first idler roller;
moving the stretch film in a first direction towards a perforation roller, wherein the perforation roller comprises a center axle and a plurality of perforation rings positioned on and axially aligned with the center axle, wherein each of the plurality of perforation rings is configured to perforate the stretch film when the stretch film passes over the plurality of perforation rings, each of the plurality of perforation rings having:
an outer ring having a plurality of pinholes extending therethrough, wherein the plurality of pinholes are spaced apart around a circumference of the outer ring;
a plurality of pins having tapered ends configured to extend through the plurality of pinholes, wherein each of the plurality of pins has a stem with a maximum diameter larger than a minimum diameter of the plurality of pinholes; and
an inner ring configured to sit inside of the outer ring and hold the plurality of pins in an extended position with the tapered ends of the plurality of pins extending through the plurality of pinholes;
perforating the stretch film with the perforation roller as the stretch film passes over the perforation roller;
moving the perforated stretch film in a second direction away from the perforation roller, wherein an angle between the first direction and the second direction is at least 150 degrees;
passing the perforated stretch film over a second idler roller; and
wrapping the perforated stretch film about a core to form a roll of perforated stretch film.

2. The method of claim 1, wherein each of the tapered ends of the plurality of pins has a length of at least 0.125 inches.

3. The method of claim 1, wherein the maximum diameter of each of the plurality of pins is less than or equal to 0.1 inches.

4. The method of claim 1, wherein perforating the stretch film comprises creating a plurality of perforations through the stretch film, wherein the plurality of perforations are spaced between one and four inches apart.

5. The method of claim 1, wherein the angle between the first direction and the second direction is at least 180 degrees.

6. A method of perforating stretch film for tightly wrapping a load, the method comprising:
extruding a stretch film, wherein the stretch film is configured to stretch by at least 100% and maintain a compressive force on the load when the load is wrapped with the stretch film;
moving the stretch film in a first direction towards a perforation roller, wherein the perforation roller comprises a center axle and a plurality of perforation rings positioned on and axially aligned with the center axle, wherein each of the plurality of perforation rings is configured to perforate the stretch film when the stretch film passes over the plurality of perforation rings;
perforating the stretch film with the perforation roller as the stretch film passes over the perforation roller;
moving the perforated stretch film in a second direction away from the perforation roller; and
wrapping the perforated stretch film about a core to form a roll of perforated stretch film.

7. The method of claim 6, wherein the stretch film is extruded using either a cast film or a blown film extrusion process.

8. The method of claim 6, wherein an angle between the first direction and the second direction is at least 150 degrees.

9. The method of claim 6, each of the plurality of perforation rings having:
an outer ring having a plurality of pinholes extending therethrough;
a plurality of pins configured to extend through the plurality of pinholes, wherein each of the plurality of pins has a maximum diameter larger than a minimum diameter of the plurality of pinholes; and
an inner ring configured to sit inside of the outer ring and hold the plurality of pins in an extended position with the plurality of pins extending through the plurality of pinholes.

10. The method of claim 9, each of the plurality of pins has a tapered end with a length of at least 0.125 inches.

11. The method of claim 9, wherein the maximum diameter of each of the plurality of pins is less than or equal to 0.1 inches.

12. The method of claim 6, wherein perforating the stretch film comprises creating a plurality of perforations through the stretch film, wherein the plurality of perforations are spaced between one and four inches apart.

13. A method of perforating stretch film for tightly wrapping a load, the method comprising:
extruding a stretch film, wherein the stretch film is configured to stretch by at least 100% and maintain a compressive force on the load when the load is wrapped with the stretch film;
perforating the stretch film; and
wrapping the perforated stretch film about a core to form a roll of perforated stretch film.

14. The method of claim 13, further comprising moving the stretch film in a first direction towards a perforation roller prior to perforating the stretch film and moving the stretch film in a second direction away from the perforation roller after perforating the stretch film, wherein an angle between the first direction and the second direction is at least 150 degrees.

15. The method of claim 13, wherein the stretch film is extruded using either a cast film or a blown film extrusion process.

16. The method of claim 13, wherein perforating the stretch film comprises perforating the stretch film with a perforation roller configured to perforate the stretch film when the stretch film passes over the perforation roller.

17. The method of claim 16, wherein the perforation roller comprises a center axle and a plurality of perforation rings positioned on and axially aligned with the center axle.

18. The method of claim 17, each of the plurality of perforation rings having:
an outer ring having a plurality of pinholes extending therethrough; and
a plurality of pins configured to extend through the plurality of pinholes, wherein each of the plurality of pins has a maximum diameter larger than a minimum diameter of the plurality of pinholes.

19. The method of claim 18, each of the plurality of perforation rings further having an inner ring configured to sit inside of the outer ring and hold the plurality of pins in an extended position with the plurality of pins extending through the plurality of pinholes.

20. The method of claim 13, wherein perforating the stretch film comprises creating a plurality of perforations through the stretch film, wherein the plurality of perforations are spaced between one and four inches apart.
